(19) United States
(12) Patent Application Publication
(10) Pub. No.: US 2026/0065883 A1
(43) Pub. Date: Mar. 5, 2026

(54) Systems and Methods for Artificial Intelligence (AI)-Driven Automatic Generation of Audio for Video

(71) Applicant: Sony Interactive Entertainment Inc., Tokyo (JP)

(72) Inventors: Brandon Sangston, San Mateo, CA (US); Joseph Sommer, San Mateo, CA (US)

(21) Appl. No.: 18/821,988

(22) Filed: Aug. 30, 2024

(51) Int. Cl. G10H 1/00; G06V 10/764

(52) U.S. Cl. CPC G10H 1/0025; G06V 10/764

(57) ABSTRACT

A first artificial intelligence (AI) engine automatically identifies and classifies subject matter content within a video and automatically generates corresponding subject matter content-related tags for audio generation, which denote temporal locations along a timeline of the video at which audio parameter specification is needed to address subject matter content. A second AI engine automatically identifies and classifies subject matter emotion within the video and automatically generates subject matter emotion-related tags for audio generation, which denote temporal locations along the timeline of the video at which audio parameter specification is needed to address subject matter emotion. A digital audio workstation interface visually conveys the timeline of the video, the subject matter content-related tags, and the subject matter emotion-related tags. The digital audio workstation interface enables user navigation along the timeline of the video and user editing of the subject matter content-related tags and the subject matter emotion-related tags.

### BACKGROUND OF THE INVENTION

The video game industry has seen many changes over the years and has been trying to find ways to enhance the video game play experience for players and increase player engagement with the video games and/or online gaming systems, which ultimately leads to increased revenue for the video game developers and providers and the video game industry in general. Video game developers have also been seeking improvement in video game production and time-to-market, which serves to improve retention of player interest and correspondingly increase revenue. It is within this context that implementations of the present disclosure arise.

### SUMMARY OF THE INVENTION

In an example embodiment, a system is disclosed for automatically generating audio for a video. The system includes a first artificial intelligence (AI) engine configured to process a video to automatically identify and classify subject matter content depicted within the video and to automatically generate subject matter content-related tags for audio generation. Each of the subject matter content-related tags denotes a particular temporal location along a timeline of the video at which audio parameter specification is needed to address subject matter content depicted within the video. The system also includes a second AI engine configured to process the video to automatically identify and classify subject matter emotion depicted within the video and to automatically generate subject matter emotion-related tags for audio generation. Each of the subject matter emotion-related tags denotes a particular temporal location along the timeline of the video at which audio parameter specification is needed to address subject matter emotion depicted within the video. The system also includes a digital audio workstation interface visually conveying the timeline of the video, the subject matter content-related tags along the timeline of the video, and the subject matter emotion-related tags along the timeline of the video. The digital audio workstation interface enables user navigation along the timeline of the video. The digital audio workstation interface also enables user editing of the subject matter content-related tags and the subject matter emotion-related tags along the timeline of the video.

In an example embodiment, a method is disclosed for automatically generating audio for a video. The method includes processing a video through a first AI engine to automatically identify and classify subject matter content depicted within the video and to automatically generate subject matter content-related tags for audio generation. Each of the subject matter content-related tags denotes a particular temporal location along a timeline of the video at which audio parameter specification is needed to address subject matter content depicted within the video. The method also includes processing the video through a second AI engine to automatically identify and classify subject matter emotion depicted within the video and to automatically generate subject matter emotion-related tags for audio generation. Each of the subject matter emotion-related tags denotes a particular temporal location along the timeline of the video at which audio parameter specification is needed to address subject matter emotion depicted within the video. The method also includes providing a digital audio workstation interface to a user. The method also includes visually conveying the timeline of the video within the digital audio workstation interface. The method also includes visually conveying the subject matter content-related tags along the timeline of the video within the digital audio workstation interface. The method also includes visually conveying the subject matter emotion-related tags along the timeline of the video within the digital audio workstation interface. The method also includes enabling user navigation along the timeline of the video within the digital audio workstation interface. The method also includes enabling user editing of the subject matter content-related tags and the subject matter emotion-related tags along the timeline of the video within the digital audio workstation interface.

### BRIEF DESCRIPTION OF THE DRAWINGS

FIG. 1 shows a system for automatically generating audio for a video, in accordance with some embodiments.

FIG. 2 shows an example depiction of the user interface, in accordance with some embodiments.

FIG. 3A shows a flowchart of a method for automatically generating audio for a video, in accordance with some embodiments.

FIG. 3B shows a flowchart of a continuation of the method of FIG. 3A for automatically generating audio for the video, in accordance with some embodiments.

FIG. 3C shows a flowchart of a continuation of the method of FIG. 3B for automatically generating audio for the video, in accordance with some embodiments.

FIG. 3D shows a flowchart of a continuation of any of the methods of FIGS. 3A, 3B, and 3C for automatically generating audio for the video, in accordance with some embodiments.

FIG. 4 shows various components of an example server device within a cloud-based computing system that can be used to implement aspects of the system of FIG. 1, and perform the methods of FIGS. 3A, 3B, and 3C, for automatically generating audio for a video, in accordance with some embodiments.

### DETAILED DESCRIPTION OF THE INVENTION

In the following description, numerous specific details are set forth in order to provide a thorough understanding of the present disclosure. It will be apparent, however, to one skilled in the art that embodiments of the present disclosure may be practiced without some or all of these specific details. In other instances, well known process operations have not been described in detail in order not to unnecessarily obscure the present disclosure.

Many modern computer applications, such as video games, virtual reality applications, augmented reality applications, virtual world applications, etc., include generation and output of video and associated audio. For ease of description, the term “video game” as used herein refers to any type of computer application in which video and associated audio is output to reflect interactive engagement of a user with the computer application, such as by way of providing video game controller inputs. For ease of description, the term “developer” as used herein refers to a real-world person that engages in developing the video game and/or the associated video and audio output of the video game. The developer of the video game is often challenged to create video and associated audio within the video game that engages and entertains players of the video game in accordance with various development objectives. In various embodiments, the development objectives can include providing visual variety, providing entertaining and engaging audio, promoting visual interest, attracting attention, conveying meaning, provoking emotion, inviting contemplation, stimulating user interaction with the video game, ensuring achievable player advancement within the video game, and ensuring sufficient player challenge within the video game, among many other development objectives. The video game may include various scenes, stages, and/or branches through which the player of the video game moves or progresses, with each having associated video and audio output. The video game development process expends extensive financial and temporal resources on creating these various scenes, stages, and/or branches of the video game and their associated video and audio output.

In many cases, the video output of the video game is substantially generated by a video game engine, and a developer (audio creator) is tasked to create audio that accompanies the video output of the video game. Also, in some cases, portions of the video output of the video game is source externally (obtained from a source other than the video game engine), such as from an AI video generation system and/or from a video recording device. In these cases as well, the developer (audio creator) is tasked to create audio that accompanies the externally sourced video output of the video game. Creation of audio for video by the developer (audio creator) is generally a tedious and time-consuming process that can adversely impact time-to-market of video games. Additionally, because sound is a primary sensory input to the video game player that has significant impact on the player's engagement with the video game, it is of interest to provide audio for the video output of the video game that is of high quality and high relevance to the visual content and emotion that is conveyed within the video output of the video game. Moreover, because the video output of the video game is often dynamic, it is of interest to have accompanying audio that is also dynamic. Therefore, it is of interest to develop methods and systems to assist the developer (audio creator) of the video game with the automatic generation of audio to accompany video output of the video game. To this end, various systems and methods are disclosed herein by which a video game developer (audio creator) can leverage AI capabilities in assisting with automatic generation of audio for the video output of the video game.

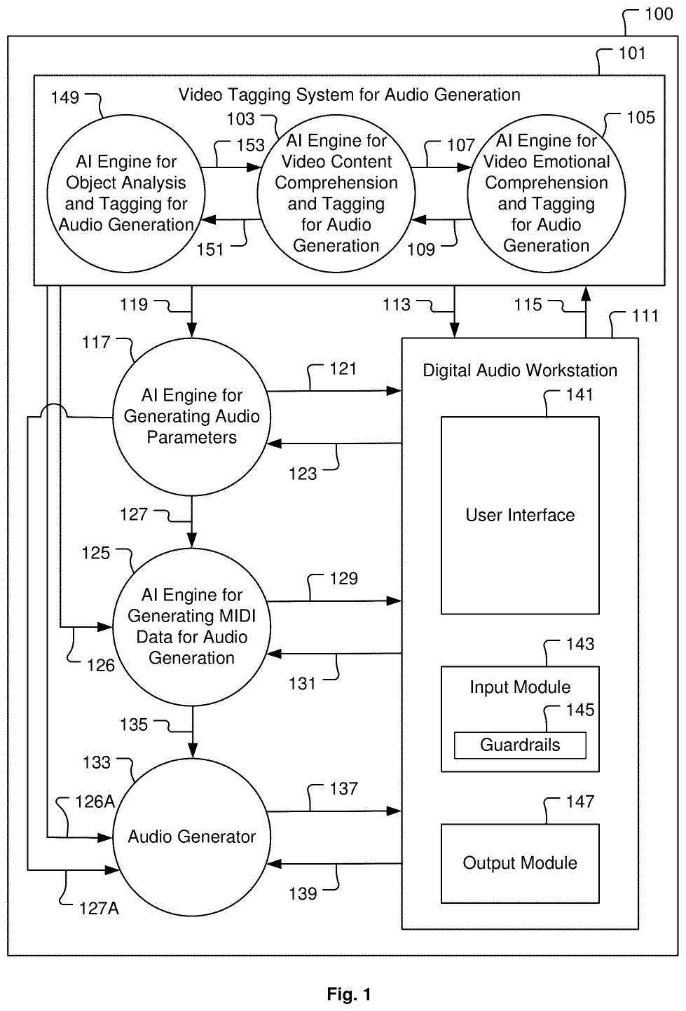

FIG. 1 shows a system 100 for automatically generating audio for a video, in accordance with some embodiments. FIG. 1 also depicts an operational flow between various components within the system 100. The system 100 is configured to assist a developer (audio creator) in the task of creating audio for a video. In some embodiments, the video is a video clip generated by a video game engine. In some of these embodiments, the video clip represents output of the video game depicting play of the video game by one or more players. In some embodiments, the video clip includes at least a portion of video externally sourced relative to the video game. The externally sourced video can be from essentially any source that is capable of generating and/or recording video, such as an AI system for generating video and/or a video camera, among others. In various embodiments, the video for which audio is to be generated by the system 100 includes one or more of output video of a video game, cinematic video, virtual reality video, augmented reality video, and real-world video, among essentially any other form of digital video that is visually displayable on a display screen of an electronic device, e.g., computer monitor, computer tablet, phone, television, and electronic display module, among others.

In some embodiments, the system 100 is engaged by a developer (audio creator) to automatically generate an audio profile for the video, which the developer (audio creator) can then work from to compose playable audio for the video. In some embodiments, the audio profile that is automatically generated by the system 100 includes temporally indexed audio parameters that correlate with content and emotion that is conveyed within the video as a function of time. In some embodiments, the audio profile that is automatically generated by the system 100 includes temporally indexed subject matter content-related tags and/or subject matter emotion-related tags that indicate notable content and/or emotion, respectively, that should be given auditory consideration along a timeline of the video. In some embodiments, the audio profile that is automatically generated by the system 100 includes musical instrument digital interface (MIDI) data for the video as a function of time. In some embodiments, the audio profile that is automatically generated by the system 100 includes playable audio for the video as a function of time. For example, in some embodiments, the system 100 is engaged by a developer (audio creator) to automatically generate a playable audio clip for a given video clip. It should be appreciated that the capacity of the system 100 to automatically generate the audio profile for the video, or even the playable audio for the video, provides for significant acceleration of the audio development process, while simultaneously enabling the developer (audio creator) to maintain and exercise creative control over the audio generation process.

The system 100 includes a video tagging system 101 for audio generation. The video tagging system 101 is configured to generate temporally indexed tags for content and/or emotion conveyed within the video that have audio implications. The video tagging system 101 is implemented using an AI backbone so that the video is processed automatically for content and emotion comprehension and for generation of corresponding subject matter content-related tags and subject matter emotion-related tags along the timeline of the video. The video tagging system 101 includes a first AI engine 103 configured to process the video to automatically identify and classify subject matter content depicted within the video and to automatically generate subject matter content-related tags for audio generation. The first AI engine 103 is configured to determine what is occurring contextually within the video at a given playback time of the video and/or over a given playback duration of the video. Each of the subject matter content-related tags denotes a particular temporal location along the timeline of the video at which audio parameter specification is needed to address subject matter content depicted within the video.

In some embodiments, each of the subject matter content-related tags for audio generation has associated metadata that includes a temporal location along the timeline of the video, an identity of the subject matter content-related tag, and a classification of subject matter content within the video associated with the subject matter content-related tag. In some embodiments, the classification of the subject matter content within the video at a corresponding time along the timeline of the video is a linguistic description or summary of what is shown and happening in the video at the corresponding time. The linguistic description includes a verbal and/or written language description of scenes, objects, persons, characters, creatures, and essentially any other subject matter that is visually displayed within the video. The linguistic description also includes a verbal and/or written language description of activity, movement, actions, and/or overall rhythm of subject matter that is visually displayed within the video. In some embodiments, the metadata of the subject matter content-related tag includes a duration of video playback time associated with the subject matter content-related tag, with the duration of video playback time commencing at the temporal index position of the subject matter content-related tag along the timeline of the video. In some embodiments, the metadata of the subject matter content-related tag includes a timing of frames of the video. The first AI engine 103 for video content comprehension and tagging provides a first layer of audio development for the video.

The video tagging system 101 also includes a second AI engine 105 configured to process the video to automatically identify and classify subject matter emotion depicted within the video and to automatically generate subject matter emotion-related tags for audio generation. The second AI engine 105 is configured to determine what is occurring emotionally within the video at a given playback time of the video and over a given playback duration of the video. Each of the subject matter emotion-related tags denotes a particular temporal location along the timeline of the video at which audio parameter specification is needed to address subject matter emotion depicted within the video. In some embodiments, the second AI engine 105 delineates specific periods of time along the timeline of the video that have respective overall dominant emotional tones. The second AI engine 105 also determines what the overall dominant emotional tone is for each of the delineated specific periods of time along the timeline of the video. In various embodiments, the overall dominant emotional tone evoked by the subject matter displayed within the video over a given delineated specific period of time along the timeline of the video is one or more of any of the following: acceptance, admiration, adoration, affection, afraid, agitation, agony, aggressive, alarm, alarmed, alienation, amazement, ambivalence, amusement, anger, anguish, annoyed, anticipating, anxious, apathy, apprehension, arrogant, assertive, astonished, attentiveness, attraction, aversion, awe, baffled, bewildered, bitter, bitter sweetness, bliss, bored, brazen, brooding, calm, carefree, careless, caring, charity, cheeky, cheerfulness, claustrophobic, coercive, comfortable, confident, confusion, contempt, content, courage, cowardly, cruelty, curiosity, cynicism, dazed, dejection, delighted, demoralized, depressed, desire, despair, determined, disappointment, disbelief, discombobulated, discomfort, discontentment, disgruntled, disgust, disheartened, dislike, dismay, disoriented, dispirited, displeasure, distraction, distress, disturbed, dominant, doubt, dread, driven, dumbstruck, eagerness, ecstasy, elation, embarrassment, empathy, enchanted, enjoyment, enlightened, ennui, enthusiasm, envy, epiphany, euphoria, exasperated, excitement, expectancy, fascination, fear, flakey, focused, fondness, freudenschade, friendliness, fright, frustrated, fury, glee, gloomy, glumness, gratitude, greed, grief, grouchiness, grumpiness, guilt, happiness, hate, hatred, helpless, homesickness, hope, hopeless, horrified, hospitable, humiliation, humility, hurt, hysteria, idleness, impatient, indifference, indignant, infatuation, infuriated, insecurity, insightful, insulted, interest, intrigued, irritated, isolated, jealousy, joviality, joy, jubilation, kind, lazy, liking, loathing, lonely, longing, loopy, love, lust, mad, melancholy, miserable, miserliness, mixed-up, modesty, moody, mortified, mystified, nasty, nauseated, negative, neglect, nervous, nostalgic, numb, obstinate, offended, optimistic, outrage, overwhelmed, panicked, paranoid, passion, patience, pensiveness, perplexed, persevering, pessimism, pity, pleased, pleasure, politeness, positive, possessive, powerless, pride, puzzled, rage, rash, rattled, regret, rejected, relaxed, relieved, reluctant, remorse, resentment, resignation, restlessness, revulsion, ruthless, sadness, satisfaction, scared, schadenfreude, scorn, self-caring, self-compassionate, self-confident, self-conscious, self-critical, self-loathing, self-motivated, self-pity, self-respecting, self-understanding, sentimentality, serenity, shame, shameless, shocked, smug, sorrow, spite, stressed, strong, stubborn, stuck, submissive, suffering, sullenness, surprise, suspense, suspicious, sympathy, tenderness, tension, terror, thankfulness, thrilled, tired, tolerance, torment, triumphant, troubled, trust, uncertainty, undermined, uneasiness, unhappy, unnerved, unsettled, unsure, upset, vengeful, vicious, vigilance, vulnerable, weak, woe, worried, worthy, and wrath, among others.

In some embodiments, each of the subject matter emotion-related tags for audio generation has associated metadata that includes a temporal location along the timeline of the video, an identity of the subject matter emotion-related tag, and a classification of subject matter emotion within the video associated with the subject matter emotion-related tag. In some embodiments, the classification of the subject matter emotion within the video at a corresponding time along the timeline of the video is a linguistic description of one or more emotion(s) that is/are being conveyed and/or that is/are associated with the subject matter that is shown and/or the events that are happening in the video at the corresponding time. The linguistic description includes a verbal and/or written language description of one or more emotion(s). The linguistic description also includes a verbal and/or written language description of a dynamic nature of the one or more emotion(s) that is/are being conveyed and/or that is/are associated with the subject matter that is shown and/or the events that are happening in the video at the corresponding time. For example, consider a scene in a video in which a person starts chuckling, and then begins laughing loudly, and then begins laughing hysterically, and then passes out. The linguistic description of the dynamic nature of the emotions in this scene may be something along the lines of amusement, transitioning to cheerfulness, transitioning to apprehension, transitioning to confusion and worry, by way of example. In some embodiments, the metadata of the subject matter emotion-related tag includes a duration of video playback time associated with the subject matter emotion-related tag, with the duration of video playback time commencing at the temporal index position of the subject matter emotion-related tag along the timeline of the video. In some embodiments, the metadata of the subject matter emotion-related tag includes a timing of frames of the video. The second AI engine 105 for video emotional comprehension and tagging provides a second layer of audio development for the video.

In some embodiments, the first AI engine 103 is configured to convey the automatically generated subject matter content-related tags for audio generation for the video to the second AI engine 105, as indicated by arrow 107, for use as input by the second AI engine 105. Also, in some embodiments, the second AI engine 105 is configured to convey the automatically generated subject matter emotion-related tags for audio generation for the video to the first AI engine 103, as indicated by arrow 109, for use as input by the first AI engine 103. In some embodiments, the first AI engine 103 and the second AI engine 105 operate in an alternating and iterative manner over a portion of the video to achieve refinement and convergence of the automatically generated subject matter content-related tags and the automatically generated subject matter emotion-related tags for the portion of the video. In some embodiments, the first AI engine 103 is operated first to automatically generate the subject matter content-related tags along the timeline of the video, which are conveyed as input to the second AI engine 105, as indicated by arrow 107. Further in these embodiments, the second AI engine 105 is operated second to automatically generate the subject matter emotion-related tags along the timeline of the video, and so on.

The system 100 further includes a third AI engine 117 configured to process the video in conjunction with both the subject matter content-related tags as generated by the first AI engine 103 and the subject matter emotion-related tags as generated by the second AI engine 105 in order to automatically generate audio parameters for each temporal location along the timeline of the video corresponding to each of the subject matter content-related tags and each temporal location along the timeline of the video corresponding to each of the subject matter emotion-related tags. The third AI engine 117 is linked to the video tagging system 101 to receive the subject matter content-related tags generated by the first AI engine 103 and the subject matter emotion-related tags generated by the second AI engine 105 as inputs, as indicated by arrow 119. In some embodiments, the audio parameters generated by the third AI engine 117 for a given subject matter content-related tag and/or a given subject matter emotion-related tag at a corresponding temporal location along the timeline of the video include one or more of pitch, melody, harmony, duration, tempo, pulse, metre, beats per minute (BPM), cut changes, rhythm, dynamics, color, timbre, length, and articulation, among others. In some embodiments, the audio parameters generated by the third AI engine 117 include delineations of time periods along the timeline of the video for which thematic musical details can be defined, along with the specifications of those thematic musical details. For example, the third AI engine 117 may delineate a time period along the timeline of the video that is associated with a climactic event and in turn generate audio parameters that specify crescendo music for the delineated time period. The third AI engine 117 for automatic generation of audio parameters for the subject matter content-related tags and the subject matter emotion-related tags provides a third layer of audio development for the video.

The system 100 further includes a fourth AI engine 125 configured to automatically generate MIDI data for the video using as input the subject matter content-related tags generated by the first AI engine 103 and the subject matter emotion-related tags generated by the second AI engine 105, as indicated by arrow 126, in conjunction with the audio parameters generated by the third AI engine 117 for temporal locations along the timeline of the video, as indicated by arrow 127. In some embodiments, the fourth AI engine 125 generates MIDI data for music and/or sounds. In some embodiments, the fourth AI engine 125 generates MIDI data for sound effects. In some embodiments, the fourth AI engine 125 generates MIDI data for a combination of music and sound effects. The MIDI data generated by the fourth AI engine 125 is reviewable and editable by a developer (audio creator) of the video game. In this manner, the fourth AI engine 125 for automatic generation of MIDI data provides a fourth layer of audio development for the video.

In some embodiments, the system 100 further includes an audio generator 133 configured to automatically generate audio for the video using the MIDI data as generated by the fourth AI engine 125 as input, as indicated by arrow 135. In some embodiments, the audio generated by the audio generator 133 is reviewable and editable by a developer (audio creator) of the video game. In some embodiments, the audio generator 133 is configured to process the MIDI data as generated by the fourth AI engine 125 through a digital musical instrument to generate the audio for the video. In some embodiments, the audio generator 133 is configured to generate original audio based on the MIDI data. In some embodiments, the audio generator 133 is configured to access and retrieve audio assets from a data store, e.g., sampler database, to generate the audio based on the MIDI data, which is defined to trigger playback of particular audio assets from the data store.

In some embodiments, the system 100 includes a fifth AI engine 149 configured to automatically detect objects displayed within the video, and automatically determine both a depth profile as a function of time and a motion profile as a function of time for each of the detected objects displayed within the video. In these embodiments, the third AI engine 117 is configured to automatically generate audio parameters for each of the detected objects within the video, such that the generated audio parameters reflect the corresponding depth profile and the corresponding motion profile as a function of time for each of the detected objects displayed within the video. In some embodiments, the fifth AI engine 149 is configured to process and segment the video in order to isolate and analyze subject matter, e.g., objects, persons, characters, creatures, etc., displayed within the video for which sound generation support is provided by the system 100. In some embodiments, the fifth AI engine 149 receives as input the subject matter content-related tags from the first AI engine 103, as indicated by arrow 151. In some embodiments, the fifth AI engine 149 is configured to correlate particular audio sounds to different locations in the video frames in order to provide the developer (audio creator) with information about the spatial aspects of the various audio content within the context of the video. For example, by way of the fifth AI engine 149, the system 100 is capable of determining and conveying to the developer (audio creator) that a particular object associated with a particular sound is barely within a video frame at a distant location within the context of the video at a first time in the video playback, and is then front and center within the context of the video at a second time in the video playback. In this example, the system 100 automatically creates adjustments of the particular sound as a function of time, such as by enhancing the quality, increasing the volume, decreasing the volume, applying a doppler shift, etc., of the particular sound between the first time and the second time along the timeline of the video. It should be understood that this is just one of many examples of how the fifth AI engine 149 is usable to automatically isolate and analyze dynamic properties of particular objects displayed within the video and in turn automatically generate corresponding dynamic audio for the particular objects. In some embodiments, the fifth AI engine 149 conveys the detected objects displayed within the video, along with their corresponding depth profiles and motion profiles, as input to the first AI engine 103, as indicated by arrow 153.

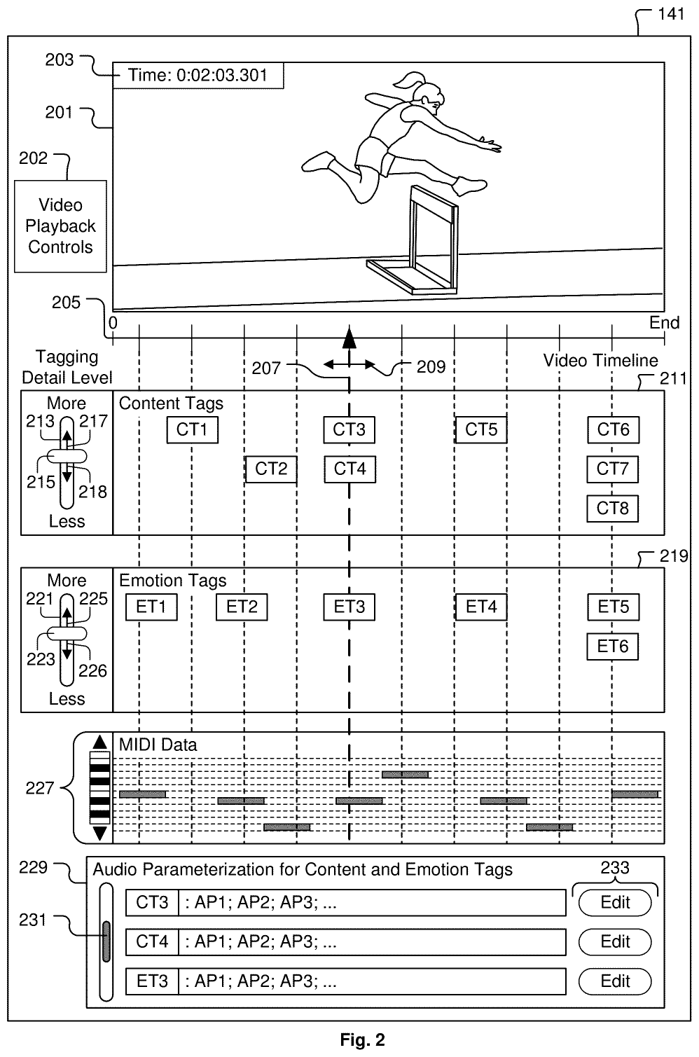

In some embodiments, the system 100 includes a digital audio workstation 111 that provides a user interface 141 to a user of the system 100. The user interface 141 is also referred to as a digital audio workstation interface 141. FIG. 2 shows an example depiction of the user interface 141, in accordance with some embodiments. The user interface 141 includes a video playback container 201 in which the video is displayed (played). The user interface 141 provides a set of video playback controls 202 that are activatable by the user of the system 100 to control playback of the video within the video playback container 201. In some embodiments, the set of video playback controls 202 includes one or more of a play control, a pause control, a stop control, a fast forward control, a rewind control, a fast rewind control, a temporal jump forward control, a temporal jump backward control, among other user-selectable controls for controlling playback of video.

The user interface 141 also shows a video timeline 205 that depicts a timeline of the video extending from a beginning of the video (denoted as 0) to an end of the video (denoted as End). In some embodiments, the user interface 141 includes a time indicator 203 that conveys a current time along the video timeline 205 corresponding to a video frame that is currently displayed within the video playback container 201. In some embodiments, the user interface 141 displays a current time indicator line 207 that indicates a location along the video timeline 205 that corresponds to the video frame that is currently displayed within the video playback container 201 and to the time that is displayed within the time indicator 203. The current time indicator line 207 moves along the video timeline 205 (either forward or backward) as the video is played and/or navigated by the user, e.g., by way of the video playback controls 202, as indicated by arrow 209. In some embodiments, the user interface 141 is configured to enable the user to directly select and move the current time indicator line 207 along the video timeline 205 to provide for navigation of the video by the user.

With reference to FIG. 1, the digital audio workstation 111 is in bi-directional data communication with the video tagging system 101, as indicated by arrows 113 and 115. In this manner, the user is able operate the digital audio workstation 111 to direct input to and operation of the first AI engine 103 for video content comprehension and tagging for audio generation. Also, the digital audio workstation 111 receives the subject matter content-related tags generated by the first AI engine 103. With reference to FIG. 2, in some embodiments, the user interface 141 is configured to display subject matter content-related tags 211 as generated by the first AI engine 103 along the video timeline 205. In some embodiments, a user selectable control (CT#) is shown for each of the subject matter content-related tags 211 at its temporal location along the video timeline 205, where # is an integer number of the subject matter content-related tag 211.

In some embodiments, the system 100 provides a precision control 213 within the user interface 141 that enables user setting of a detail level at which the first AI engine 103 processes the video to automatically generate the subject matter content-related tags 211 for the video. In some embodiments, the precision control 213 is visually displayed as a slider control 215 that is movable in a first direction 217 to increase the detail level for subject matter content-related tag generation and that is movable in a second direction 218 to decrease the detail level for subject matter content-related tag generation. When the detail level for subject matter content-related tag generation is increased by moving of the slider control 215 further in the first direction 217, the first AI engine 103 is directed to be more aggressive in processing the video to identify subject matter within the video for which subject matter content-related tags 211 are generated, thus increasing the probability of having subject matter content-related tags 211 generated by the first AI engine 103. Conversely, when the detail level for subject matter content-related tag generation is decreased by moving of the slider control 215 further in the second direction 218, the first AI engine 103 is directed to be less aggressive in processing the video to identify subject matter within the video for which subject matter content-related tags 211 are generated, thus decreasing the probability of having subject matter content-related tags 211 generated by the first AI engine 103.

The user is also able operate the digital audio workstation 111 to direct input to and operation of the second AI engine 105 for video emotion comprehension and tagging for audio generation. The digital audio workstation 111 receives the subject matter emotion-related tags generated by the second AI engine 105. With reference to FIG. 2, in some embodiments, the user interface 141 is configured to display subject matter emotion-related tags 219 as generated by the second AI engine 105 along the video timeline 205. In some embodiments, a user selectable control (ET#) is shown for each of the subject matter emotion-related tags 219 at its temporal location along the video timeline 205, where # is an integer number of the subject matter emotion-related tag 219.

In some embodiments, the system 100 provides a precision control 221 within the user interface 141 that enables user setting of a detail level at which the second AI engine 105 processes the video to automatically generate the subject matter emotion-related tags 219 for the video. In some embodiments, the precision control 221 is visually displayed as a slider control 223 that is movable in a first direction 225 to increase the detail level for subject matter emotion-related tag generation and that is movable in a second direction 226 to decrease the detail level for subject matter emotion-related tag generation. When the detail level for subject matter emotion-related tag generation is increased by moving of the slider control 223 further in the first direction 225, the second AI engine 105 is directed to be more aggressive in processing the video to identify emotional presence within the video for which subject matter emotion-related tags 219 are generated, thus increasing the probability of having subject matter emotion-related tags 219 generated by the second AI engine 103. Conversely, when the detail level for subject matter emotion-related tag generation is decreased by moving of the slider control 223 further in the second direction 226, the second AI engine 105 is directed to be less aggressive in processing the video to identify emotional presence within the video for which subject matter emotion-related tags 219 are generated, thus decreasing the probability of having subject matter emotion-related tags 219 generated by the second AI engine 103.

Also, the digital audio workstation 111 is in bi-directional data communication with the third AI engine 117 for automatic generation of audio parameters, as indicated by arrows 121 and 123. In some embodiments, the user interface 141 includes an audio parameter specification container 229 in which the audio parameters (AP#) are shown for each of the subject matter content-related tags 211 as generated by the first AI engine 103 and for each of the subject matter emotion-related tags 219 as generated by the second AI engine 103, where # is an identification value. In some embodiments, each of the audio parameters (AP#) is listed by name and value within the audio parameter specification container 229 in association with its subject matter content-related tag 211 (CT#) and/or subject matter emotion-related tag 219 (ET#), as the case may be. It should be understood that different audio parameters (AP#) can be specified for different ones of the subject matter content-related tags 211 (CT#) and subject matter emotion-related tags 219 (ET#), such that some subject matter content-related tags 211 (CT#) may have different audio parameters (AP#) specified as compared to others, and such that some subject matter emotion-related tags 219 (ET#) may have different audio parameters (AP#) specified as compared to others. The user interface 141 also provides edit controls 233 for the audio parameters (AP#) for each of the subject matter content-related tags 211 (CT#) and subject matter emotion-related tags 219 (ET#), to enable the developer (audio creator) to manually adjust any one or more of the corresponding audio parameters (AP#) as generated by the third AI engine 117, to manually remove any one or more of the corresponding audio parameters (AP#) as generated by the third AI engine 117, and/or to manually add one or more audio parameters (AP#) to a particular subject matter content-related tag 211 (CT#) and/or a particular subject matter emotion-related tag 219 (ET#).

In some embodiments, such as shown in the example of FIG. 2, the audio parameter specification container 229 is set to show the subject matter content-related tag(s) 211 (CT#) and/or subject matter emotion-related tag(s) 219 (ET#) that correspond to a current location of the current time indicator line 207 along the video timeline 205. In some embodiments, the audio parameter specification container 229 is set to show a listing of all of the subject matter content-related tag(s) 211 (CT#) and subject matter emotion-related tag(s) 219 (ET#), and associated audio parameters (AP#) generated for the video. In some embodiments, the audio parameter specification container 229 provides for sorting of the subject matter content-related tag(s) 211 (CT#) and subject matter emotion-related tag(s) 219 (ET#), and associated audio parameters (AP#), by one or more of a tag identifier, a tag temporal location along the timeline of the video, a tag type, an audio parameter type, an audio parameter count, and essentially any other type of sortable information conveyed within the audio parameter specification container 229. Also, in some embodiments, the user interface 141 includes a tag navigation control 231, e.g., scroll bar, scroll buttons, jump buttons, etc., that enables the user of the system 100 to navigate through the subject matter content-related tag(s) 211 (CT#) and subject matter emotion-related tag(s) 219 (ET#), and associated audio parameters (AP#), within the audio parameter specification container 229.

With reference to FIG. 1, the digital audio workstation 111 is in bi-directional data communication with the fourth AI engine 125 for automatic generation of MIDI data, as indicated by arrows 129 and 131. Also, with reference to FIG. 2, in some embodiments, the user interface 141 is configured to show the MIDI data that is generated by the fourth AI engine 125 for the video. More specifically, in some embodiments, the user interface 141 includes a MIDI data container 227 that presents the MIDI data generated by the fourth AI engine 125 as a function of time along the video timeline 205. In some embodiments, the MIDI data is directly editable by the user of the system 100 through the user interface 141. Additionally, the digital audio workstation 111 is in bi-directional data communication with the audio generator 133 for generation of audio based on the MIDI data, as indicated by arrows 137 and 139. The audio generated by the audio generator 133 is exportable from the system 100. Also, in some embodiments, the system 100 provides for exportation of the MIDI data as shown in the MIDI data container 227, which enables use of the MIDI data as input to an audio generator that is external to the system 100.

The digital audio workstation 111 provides an input module 143 that is configured to give the user of the system 100 control over how the system 100 is engaged to automatically generate audio for the video. For example, in some embodiments, the input module 143 is configured to enable the user of the system 100, e.g., the developer (audio creator), to specify which layers of audio development for the video is/are to be performed by the system 100. More specifically, by way of the input module 143, the user of the system 100 is able to direct engagement of one or more of the first AI engine 103 for automatic generation of subject matter content-related tags (CT#), the second AI engine 105 for automatic generation of subject matter content-related tags (ET#), the third AI engine 117 for audio parameter (AP#) generation, the fourth AI engine 125 for MIDI data generation, the fifth AI engine 149 for automatic object detection and analysis within the video, and the audio generator 133 for generation of playable audio for the video. The system 100 allows the user to step in at any layer of audio development for the video, such that the user has creative control of the audio generation process.

In some embodiments, the input module 143 is configured to allow the user to operate the system 100 of fully automatic mode, such that upon receiving the video as input, the system 100 automatically engages each of the first AI engine 103, the second AI engine 105, the third AI engine 117, the fourth AI engine 125, the fifth AI engine 149, and the audio generator 133, as needed, to generate playable audio for the video. In some embodiments, the input module 143 is configured to allow the user to control an operational flow of the system 100, such that upon providing the video as input to the system 100, the user is able to independently control engagement of each of the first AI engine 103, the second AI engine 105, the third AI engine 117, the fourth AI engine 125, the fifth AI engine 149, and the audio generator 133. In these embodiments, the user of the system 100 is able to review and adjust, if needed, the output of each of the first AI engine 103, the second AI engine 105, the third AI engine 117, the fourth AI engine 125, and the fifth AI engine 149, before that output is used by the system 100 as input in a subsequent layer of the audio development for the video.

Additionally, in some embodiments, the input module 143 enables the user of the system 100 to specify one or more guardrails 145 for use in generating the audio for the video. In some embodiments, the guardrails 145 are specified as inputs to one or more of the first AI engine 103, the second AI engine 105, the third AI engine 117, the fourth AI engine 125, the fifth AI engine 149. For example, in some embodiments, the guardrails 145 enable the user of the system 100 to engage in prompt engineering to guide the system 100 toward a desired audio outcome for the video. Also, in some embodiments, the guardrails 145 are used to direct the system 100 to focus on particular subject matter within the video in generating the audio for the video. In this manner, the guardrails 145 serve as a subject matter filtering device that is applied during automatic processing of the video by the first AI engine 103, the second AI engine 105, and the fifth AI engine 149 of the video tagging system 101. For example, in some embodiments, the guardrails 145 are specified by the user of the system 100 to focus on a particular character within the video when generating the audio for the video. It should be understood that this is one example of an essentially limitless number of ways in which the guardrails 145 can be specified to direct the system 100 to filter subject matter displayed within the video during automatic generation of audio for the video.

The digital audio workstation 111 further includes an output module 147 for organizing and conveying various outputs generated by the system 100. In some embodiments, the output module 147 is configured to organize and convey to the user of the system 100 the output generated by any one or more of the first AI engine 103, the second AI engine 105, the third AI engine 117, the fourth AI engine 125, the fifth AI engine 149, and the audio generator 133. It should be understood that the system 100 is usable to accelerate audio development for a video. In some embodiments, the various outputs provided by the system 100, by way of the output module 147, are usable by the developer (audio creator) as at least a starting point for developing final audio for a given video. In some embodiments, the system 100 is used to automatically generate some audio for a video that the developer (audio creator) can then work with and refine to create a final audio clip for the video.

In some embodiments, the fourth AI engine 125 generates multiple tracks of MIDI data that are viewable and manipulatable within the digital audio workstation 111. Also, in some embodiments, the audio generator 133 generates multiple tracks of audio that are viewable and manipulatable within the digital audio workstation 111. In some embodiments, the multiple tracks of MIDI data and/or audio are presented to the user of the system 100 within the digital audio workstation 111, such that the multiple tracks of MIDI data and/or audio provide a foundation from which the developer (audio creator) can work to develop the final audio for a video. In some embodiments, there are separate tracks generated by the system 100 for each unique sound source in the generated MIDI data and/or in the generated audio. For example, the generated MIDI data and/or audio can include a first track for a violin melody, a second track for a piano, a third track for percussion, and additional tracks for various other sound sources within the video scene for which the system 100 is generating audio. In some embodiments, the system 100 operates to generate a separate MIDI data track and/or audio track for each unique sound source in the session, each of which can be comprised of multichannel audio, and each of which can have its own audio processing chain. In some embodiments, the system 100 generates a large number of individually controllable MIDI data tracks and/or audio tracks, which are ultimately mixed into a single audio output, e.g., a stereo audio output. The digital audio workstation 111 is configured to accommodate the processing and manipulation of the large number of individually controllable MIDI data tracks and/or audio tracks, along with the mixing of the multiple tracks into the final audio output. Moreover, in some embodiments, the separate MIDI tracks mentioned have virtual instruments/synthesizers/samplers configured to ingest MIDI data and output corresponding audio. In some embodiments, the various virtual instruments/synthesizers/samplers are audio plugins to the digital audio workstation 111, which can be either acquired from a plugin provider or custom-generated by the developer (creator). In various embodiments, the audio generator 133 integrates with third-party software and/or includes its own MIDI-capable audio generators.

In some embodiments, the audio generator 133 is configured to generate audio without reference to MIDI data. In these embodiments, the audio generator 133 is configured to automatically generate audio for the video using as input the subject matter content-related tags generated by the first AI engine 103 and the subject matter emotion-related tags generated by the second AI engine 105, as indicated by arrow 126A, in conjunction with the audio parameters generated by the third AI engine 117 for temporal locations along the timeline of the video, as indicated by arrow 127A. In some of these embodiments, the audio generator 133 is AI-equipped for purposes of generating the audio for the video. In these embodiments, the fourth AI engine 125 for generating the MIDI data is either disengaged within the system 100 or is not present within the system 100. In some embodiments, the audio generator 133 is configured to acquire sound assets from a sound database that is in data communication with the system 100 and/or implement one or more generative audio model(s) that expose audio creation controls to the developer (creator) by way of the digital audio workstation 111.

In some embodiments, with the audio generator 133 connected to a sound database, the audio generator 133 is configured to use the subject matter content-related tags generated by the first AI engine 103 and the subject matter emotion-related tags generated by the second AI engine 105 to determine, acquire, and implement appropriate sounds and/or sound variations from the database in generating the audio for the video. In these embodiments, the developer (creator) is able to view and edit the audio that is generated by the audio generator 133 within the digital audio workstation 111, such as by adjusting timing, volume, filtering, and/or any other audio parameter. Also, in some embodiments, the audio generator 133 is configured to directly synthesize sounds by implementing one or more generative model(s). In some embodiments, the audio generator 133 uses the subject matter content-related tags generated by the first AI engine 103 and the subject matter emotion-related tags generated by the second AI engine 105 to inform selection and parametrization of these generative audio synthesizers. Also, in some embodiments, the generative audio synthesizers expose meaningful audio controls to the user of the system 100 for audio editing and/or modification. In various embodiments, the audio generator 133 implements a large foundational model for generative audio, and/or a collection of smaller scope models/generators for different classes of sounds. In various embodiments, the generators implemented by the audio generator 133 can be either AI-based or non-AI-based. For example, in some embodiments, non-AI-based generators are configured to rely on more traditional digital signal processing (DSP) and audio synthesis techniques, such as granular synthesis, by way of example, among others. Also, in some embodiments, the audio generator 133 implements a generative ambience model that exposes various controls, such as for type of environment, mood, color, density, etc. Also, in various embodiments, the system 100 is configured to enable the developer (creator) to edit and/or modify the control parameters of the generative models that are implemented within the audio generator 133. Also, in some embodiments, the audio generator 133 implements generative models for particular types of sound. For example, in some embodiments, the audio generator 133 implements a generative footstep sound model, a generative car engine sound model, among essentially any other generative sound model as needed to generator audio for the video..

It should be appreciated that the system 100 is advantageously applicable to a limitless number of practical applications in which audio needs to be generated for a video. For example, the system 100 is particularly useful in supporting generation of audio for video trailers, such as for a video trailer for a video game. In another example, the system 100 is particularly useful in supporting generation of music to accompany cinematic video clips included within video output of a video game. In another example, the system 100 is particularly useful in generating audio to accompany short clips of video output of a video game, such as recap video clips of video game play. It should be appreciated that the audio that is generated by the system 100 for the video clips can be unique in comparison with the audio that normally accompanies play of the video game, which provides an additional layer of entertainment to foster further player and/or spectator engagement with the video game. Again, as mentioned above, these are just a few of a limitless number of practical applications of the system 100 for automatically supporting audio generation for video.

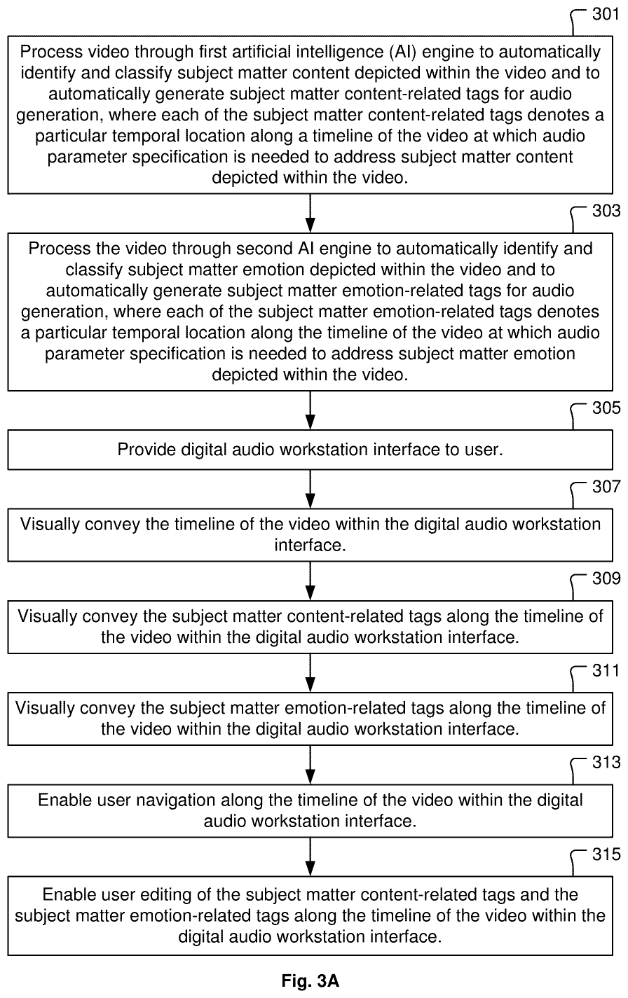

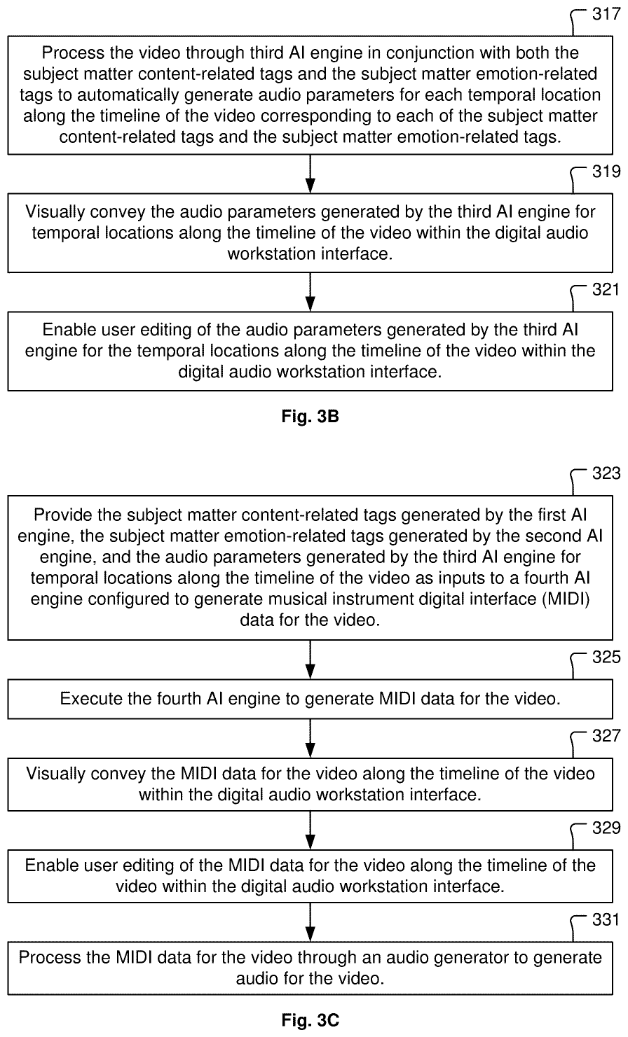

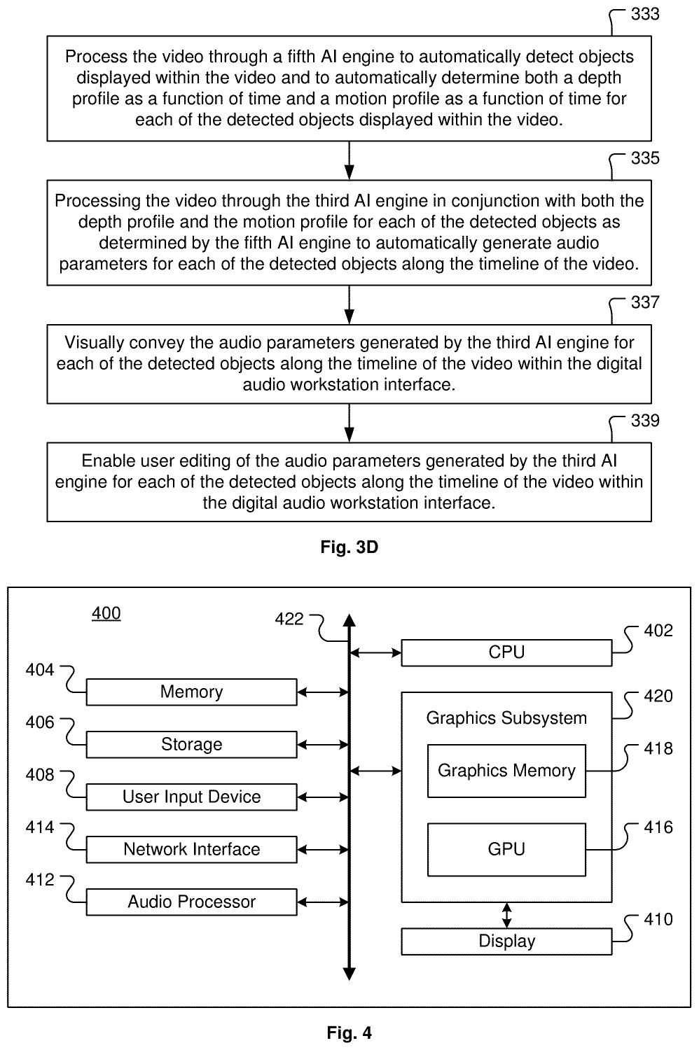

FIG. 3A shows a flowchart of a method for automatically generating audio for a video, in accordance with some embodiments. In some embodiments, the video is generated by a video game engine. In some embodiments, the video is sourced from an AI system. In some embodiments, the video is created by a video recording device. The method of FIG. 3A is performed by the system 100. The method includes an operation 301 for processing the video through the first AI engine 103 to automatically identify and classify subject matter content depicted within the video and to automatically generate subject matter content-related tags (CT#) for audio generation. Each of the subject matter content-related tags (CT#) denotes a particular temporal location along the timeline 205 of the video at which audio parameter (AP#) specification is needed to address subject matter content depicted within the video. In some embodiments, the method includes generating metadata for each of the subject matter content-related tags (CT#) for audio generation that includes a temporal location, an identity, and a classification of corresponding subject matter content within the video. In some embodiments, the method includes providing the precision control 213 within the digital audio workstation interface 141 that enables user setting of a detail level at which the first AI engine 103 processes the video.

The method also includes an operation 303 for processing the video through the second AI engine 105 to automatically identify and classify subject matter emotion depicted within the video and to automatically generate subject matter emotion-related tags (ET#) for audio generation. Each of the subject matter emotion-related tags (ET#) denotes a particular temporal location along the timeline 205 of the video at which audio parameter (AP#) specification is needed to address subject matter emotion depicted within the video. In some embodiments, the method includes generating metadata for each of the subject matter emotion-related tags (ET#) for audio generation that includes a temporal location, an identity, and a classification of corresponding subject matter emotion within the video. In some embodiments, the method includes providing the precision control 221 within the digital audio workstation interface 141 that enables user setting of a detail level at which the second AI engine 105 processes the video.

The method also includes an operation 305 for providing the digital audio workstation interface 141 to the user of the system 100. The method also includes an operation 307 for visually conveying the timeline 205 of the video within the digital audio workstation interface 141. The method also includes an operation 309 for visually conveying the subject matter content-related tags (CT#) along the timeline 205 of the video within the digital audio workstation interface 141. The method also includes an operation 311 for visually conveying the subject matter emotion-related tags (ET#) along the timeline 205 of the video within the digital audio workstation interface 141. The method also includes an operation 313 for enabling the user to navigate along the timeline 205 of the video within the digital audio workstation interface 141. The method also includes an operation 315 for enabling the user to edit the subject matter content-related tags (CT#) and the subject matter emotion-related tags (ET#), and their associate audio parameters (AP#), along the timeline 205 of the video within the digital audio workstation interface 141.

FIG. 3B shows a flowchart of a continuation of the method of FIG. 3A for automatically generating audio for the video, in accordance with some embodiments. The method of FIG. 3B is performed by the system 100. The method includes an operation 317 for processing the video through the third AI engine 117 in conjunction with both the subject matter content-related tags (CT#) and the subject matter emotion-related tags (ET#) to automatically generate audio parameters (AP#) for each temporal location along the timeline 205 of the video corresponding to each of the subject matter content-related tags (CT#) and the subject matter emotion-related tags (ET#). The method also includes an operation 319 for visually conveying the audio parameters (AP#) generated by the third AI engine 117 for temporal locations along the timeline 205 of the video within the digital audio workstation interface 141. The method also includes an operation 321 for enabling the user to edit the audio parameters (AP#) generated by the third AI engine 117 for the temporal locations along the timeline 205 of the video within the digital audio workstation interface 141. In some embodiments, the audio parameters (AP#) for a given temporal location along the timeline 205 of the video include one or more of pitch, melody, harmony, duration, pulse, metre, rhythm, dynamics, color, timbre, length, and articulation, among any other audio parameter.

FIG. 3C shows a flowchart of a continuation of the method of FIG. 3B for automatically generating audio for the video, in accordance with some embodiments. The method of FIG. 3C is performed by the system 100. The method includes an operation 323 for providing the subject matter content-related tags (CT#) generated by the first AI engine 103, the subject matter emotion-related tags (ET#) generated by the second AI engine 105, and the audio parameters (AP#) generated by the third AI engine 117 for temporal locations along the timeline 205 of the video as inputs to the fourth AI engine 125 configured to MIDI data for the video. The method also includes an operation 325 for executing the fourth AI engine 125 to generate MIDI data for the video. The method also includes an operation 327 for visually conveying the MIDI data for the video along the timeline 205 of the video within the digital audio workstation interface 141. The method also includes an operation 329 for enabling the user to edit the MIDI data for the video along the timeline 205 of the video within the digital audio workstation interface 141. The method also includes an operation 331 for processing the MIDI data for the video through the audio generator 133 to generate audio for the video.

FIG. 3D shows a flowchart of a continuation of any of the methods of FIGS. 3A, 3B, and 3C for automatically generating audio for the video, in accordance with some embodiments. The method of FIG. 3D is performed by the system 100. The method includes an operation 333 for processing the video through the fifth AI engine 149 to automatically detect objects displayed within the video and to automatically determine both the depth profile as a function of time and the motion profile as a function of time for each of the detected objects displayed within the video. The method also includes generation of subject matter content-related tags (CT#) and/or subject matter emotion-related tags (ET#) for the detected objects as determined by the fifth AI engine 149. The method also includes an operation 335 for processing the video through the third AI engine 117 in conjunction with both the depth profile and the motion profile for each of the detected objects as determined by the fifth AI engine 149 to automatically generate audio parameters (AP#) for each of the detected objects along the timeline 205 of the video. The method also includes an operation 337 for visually conveying the audio parameters (AP#) generated by the third AI engine 117 in association with the subject matter content-related tags (CT#) and/or subject matter emotion-related tags (ET#) for each of the detected objects along the timeline 205 of the video within the digital audio workstation interface 141. The method also includes an operation 339 for enabling the user to edit the audio parameters (AP#) generated by the third AI engine 117 for each of the detected objects along the timeline 205 of the video within the digital audio workstation interface 141.

FIG. 4 shows various components of an example server device 400 within a cloud-based computing system that can be used to implement aspects of the system 100 of FIG. 1, and perform the methods of FIGS. 3A, 3B, and 3C, for automatically generating audio for a video, in accordance with some embodiments. This block diagram illustrates the server device 400 that can incorporate or can be a personal computer, video game console, personal digital assistant, a head mounted display (HMD), a wearable computing device, a laptop or desktop computing device, a server or any other digital computing device, suitable for practicing an embodiment of the disclosure. The server device (or simply referred to as “server” or “device”) 400 includes a central processing unit (CPU) 402 for running software applications and optionally an operating system. The CPU 402 may be comprised of one or more homogeneous or heterogeneous processing cores. For example, the CPU 402 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 400 may be localized to a designer designing a game segment or remote from the designer (e.g., back-end server processor), or one of many servers using virtualization in the cloud-based gaming system 400 for remote use by designers.

Memory 404 stores applications and data for use by the CPU 402. Storage 406 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 408 communicate user inputs from one or more users to device 400, examples of which may include keyboards, mice, joysticks, touch pads, touch screens, still or video recorders/cameras, tracking devices for recognizing gestures, and/or microphones. Network interface 414 allows device 400 to communicate with other computer systems via an electronic communications network, and may include wired or wireless communication over local area networks and wide area networks such as the internet. An audio processor 412 is adapted to generate analog or digital audio output from instructions and/or data provided by the CPU 402, memory 404, and/or storage 406. The components of device 400, including CPU 402, memory 404, data storage 406, user input devices 408, network interface 414, and audio processor 412 are connected via one or more data buses 422.

A graphics subsystem 420 is further connected with data bus 422 and the components of the device 400. The graphics subsystem 420 includes a graphics processing unit (GPU) 416 and graphics memory 418. Graphics memory 418 includes a display memory (e.g., a frame buffer) used for storing pixel data for each pixel of an output image. Graphics memory 418 can be integrated in the same device as GPU 416, connected as a separate device with GPU 416, and/or implemented within memory 404. Pixel data can be provided to graphics memory 418 directly from the CPU 402. Alternatively, CPU 402 provides the GPU 416 with data and/or instructions defining the desired output images, from which the GPU 416 generates the pixel data of one or more output images. The data and/or instructions defining the desired output images can be stored in memory 404 and/or graphics memory 418. In an embodiment, the GPU 416 includes 3D rendering capabilities for generating pixel data for output images from instructions and data defining the geometry, lighting, shading, texturing, motion, and/or camera parameters for virtual object(s) within a scene. The GPU 416 can further include one or more programmable execution units capable of executing shader programs.

The graphics subsystem 420 periodically outputs pixel data for an image from graphics memory 418 to be displayed on display device 410. Display device 410 can be any device capable of displaying visual information in response to a signal from the device 400, including CRT, LCD, plasma, and OLED displays. In addition to display device 410, the pixel data can be projected onto a projection surface. Device 400 can provide the display device 410 with an analog or digital signal, for example.

Implementations of the present disclosure for the systems and methods for automatically generating audio for a video may be practiced using various computer device configurations including hand-held devices, microprocessor systems, microprocessor-based or programmable consumer electronics, minicomputers, mainframe computers, head-mounted display, wearable computing devices and the like. Embodiments of the present disclosure can also be practiced in distributed computing environments where tasks are performed by remote processing devices that are linked through a wire-based or wireless network.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although various method operations were described in a particular order, it should be understood that other housekeeping operations may be performed in between the method operations. Also, method operations may be adjusted so that they occur at slightly different times or in parallel with each other. Also, method operations may be distributed in a system which allows the occurrence of the processing operations at various intervals associated with the processing.

One or more embodiments can also be fabricated as computer readable code (program instructions) on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices, or any other type of device that is capable of storing digital data. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

What is claimed is:

1. A system for automatically generating audio for a video, comprising:
a first artificial intelligence (AI) engine configured to process a video to automatically identify and classify subject matter content depicted within the video and to automatically generate subject matter content-related tags for audio generation, wherein each of the subject matter content-related tags denotes a particular temporal location along a timeline of the video at which audio parameter specification is needed to address subject matter content depicted within the video;
a second AI engine configured to process the video to automatically identify and classify subject matter emotion depicted within the video and to automatically generate subject matter emotion-related tags for audio generation, wherein each of the subject matter emotion-related tags denotes a particular temporal location along the timeline of the video at which audio parameter specification is needed to address subject matter emotion depicted within the video; and
a digital audio workstation interface visually conveying the timeline of the video, the subject matter content-related tags along the timeline of the video, and the subject matter emotion-related tags along the timeline of the video, the digital audio workstation interface enabling user navigation along the timeline of the video, the digital audio workstation interface enabling user editing of the subject matter content-related tags and the subject matter emotion-related tags along the timeline of the video.

2. The system as recited in claim 1, wherein each of the subject matter content-related tags for audio generation has associated metadata that includes a temporal location, an identity, and a classification of corresponding subject matter content within the video, and wherein each of the subject matter emotion-related tags for audio generation has associated metadata that includes a temporal location, an identity, and a classification of corresponding subject matter emotion within the video.

3. The system as recited in claim 1, wherein the video is generated by a video game engine.

4. The system as recited in claim 1, further comprising:
a third AI engine configured to process the video in conjunction with both the subject matter content-related tags and the subject matter emotion-related tags to automatically generate audio parameters for each temporal location along the timeline of the video corresponding to each of the subject matter content-related tags and the subject matter emotion-related tags, wherein the digital audio workstation interface is configured to visual convey the audio parameters generated by the third AI engine for temporal locations along the timeline of the video, the digital audio workstation interface configured to enable user editing of the audio parameters generated by the third AI engine for the temporal locations along the timeline of the video.

5. The system as recited in claim 4, wherein the audio parameters for a given temporal location along the timeline of the video include one or more of pitch, melody, harmony, duration, pulse, metre, rhythm, dynamics, color, timbre, length, and articulation.

6. The system as recited in claim 4, further comprising:
a fourth AI engine configured to generate musical instrument digital interface (MIDI) data for the video using as input the subject matter content-related tags generated by the first AI engine, the subject matter emotion-related tags generated by the second AI engine, and the audio parameters generated by the third AI engine for temporal locations along the timeline of the video.

7. The system as recited in claim 6, wherein the digital audio workstation interface is configured to visual convey the MIDI data for the video along the timeline of the video, the digital audio workstation interface configured to enable user editing of the MIDI data along the timeline of the video.

8. The system as recited in claim 6, further comprising:
an audio generator configured to use the MIDI data generated by the fourth AI engine to generate audio for the video.

9. The system as recited in claim 6, further comprising:
a fifth AI engine configured to automatically detect objects displayed within the video, the fifth AI engine configured to automatically determine both a depth profile as a function of time and a motion profile as a function of time for each of the detected objects displayed within the video, the third AI engine configured to automatically generate audio parameters for each of the detected objects within the video that reflect the corresponding depth profile and the corresponding motion profile.

10. The system as recited in claim 1, wherein the digital audio workstation interface visually conveys a precision control that enables user setting of a detail level at which the first AI engine and the second AI engine process the video.

11. The system as recited in claim 4, further comprising:
an audio generator configured to process the subject matter content-related tags generated by the first AI engine, the subject matter emotion-related tags generated by the second AI engine, and the audio parameters generated by the third AI engine for temporal locations along the timeline of the video to generate audio for the video.

12. A method for automatically generating audio for a video, comprising:
processing a video through a first artificial intelligence (AI) engine to automatically identify and classify subject matter content depicted within the video and to automatically generate subject matter content-related tags for audio generation, wherein each of the subject matter content-related tags denotes a particular temporal location along a timeline of the video at which audio parameter specification is needed to address subject matter content depicted within the video;
processing the video through a second AI engine to automatically identify and classify subject matter emotion depicted within the video and to automatically generate subject matter emotion-related tags for audio generation, wherein each of the subject matter emotion-related tags denotes a particular temporal location along the timeline of the video at which audio parameter specification is needed to address subject matter emotion depicted within the video;
providing a digital audio workstation interface to a user;
visually conveying the timeline of the video within the digital audio workstation interface;
visually conveying the subject matter content-related tags along the timeline of the video within the digital audio workstation interface;
visually conveying the subject matter emotion-related tags along the timeline of the video within the digital audio workstation interface;
enabling user navigation along the timeline of the video within the digital audio workstation interface; and
enabling user editing of the subject matter content-related tags and the subject matter emotion-related tags along the timeline of the video within the digital audio workstation interface.

13. The method as recited in claim 12, further comprising:
generating metadata for each of the subject matter content-related tags for audio generation that includes a temporal location, an identity, and a classification of corresponding subject matter content within the video; and
generating metadata for each of the subject matter emotion-related tags for audio generation that includes a temporal location, an identity, and a classification of corresponding subject matter emotion within the video.

14. The method as recited in claim 12, wherein the video is generated by a video game engine.

15. The method as recited in claim 12, further comprising:
processing the video through a third AI engine in conjunction with both the subject matter content-related tags and the subject matter emotion-related tags to automatically generate audio parameters for each temporal location along the timeline of the video corresponding to each of the subject matter content-related tags and the subject matter emotion-related tags;
visually conveying the audio parameters generated by the third AI engine for temporal locations along the timeline of the video within the digital audio workstation interface; and
enabling user editing of the audio parameters generated by the third AI engine for the temporal locations along the timeline of the video within the digital audio workstation interface.

16. The method as recited in claim 15, wherein the audio parameters for a given temporal location along the timeline of the video include one or more of pitch, melody, harmony, duration, pulse, metre, rhythm, dynamics, color, timbre, length, and articulation.

17. The method as recited in claim 15, further comprising:
providing the subject matter content-related tags generated by the first AI engine, the subject matter emotion-related tags generated by the second AI engine, and the audio parameters generated by the third AI engine for temporal locations along the timeline of the video as inputs to a fourth AI engine configured to generate musical instrument digital interface (MIDI) data for the video; and
executing the fourth AI engine to generate MIDI data for the video.

18. The method as recited in claim 17, further comprising:
visually conveying the MIDI data for the video along the timeline of the video within the digital audio workstation interface; and
enabling user editing of the MIDI data for the video along the timeline of the video within the digital audio workstation interface.

19. The method as recited in claim 17, further comprising:
processing the MIDI data for the video through an audio generator to generate audio for the video.

20. The method as recited in claim 17, further comprising:
processing the video through a fifth AI engine to automatically detect objects displayed within the video and to automatically determine both a depth profile as a function of time and a motion profile as a function of time for each of the detected objects displayed within the video;
processing the video through the third AI engine in conjunction with both the depth profile and the motion profile for each of the detected objects as determined by the fifth AI engine to automatically generate audio parameters for each of the detected objects along the timeline of the video;
visually conveying the audio parameters generated by the third AI engine for each of the detected objects along the timeline of the video within the digital audio workstation interface; and
enabling user editing of the audio parameters generated by the third AI engine for each of the detected objects along the timeline of the video within the digital audio workstation interface.

21. The method as recited in claim 17, further comprising:
processing the subject matter content-related tags generated by the first AI engine, the subject matter emotion-related tags generated by the second AI engine, and the audio parameters generated by the third AI engine for temporal locations along the timeline of the video through an audio generator to generate audio for the video.

22. The method as recited in claim 12, further comprising:
providing a precision control within the digital audio workstation interface that enables user setting of a detail level at which the first AI engine and the second AI engine process the video.
